(19) United States
(12) Patent Application Publication
(10) Pub. No.: US 2008/0014379 A1
(43) Pub. Date: Jan. 17, 2008

(54) Scratch Type Printed Material

(75) Inventors: Yoshiaki Shibaoka, Tokyo (JP); Hiroshi Kawai, Tokyo (JP); Fumihito Kobayashi, Tokyo (JP)

Correspondence Address: GREENBLUM & BERNSTEIN, P.L.C., 1950 ROLAND CLARKE PLACE, RESTON, VA, 20191, US

(73) Assignee: KYODO PRINTING CO., LTD., Tokyo (JP)

(21) Appl. No.: 11/718,671

(22) PCT Filed: Nov. 10, 2005
(86) PCT No.: PCT/JP05/20565

§ 371 Date: May 4, 2007

(30) Foreign Application Priority Data
Nov. 11, 2004 (JP) 2004-327450

(51) Int. Cl. B44F 1/10

(52) U.S. Cl. 428/29

(57) ABSTRACT

A scratch type printed material that is hardly reproduced is provided. An area of a scratch layer 104 is smaller than an area of a release layer 103, and a printing layer 105 is formed on the portion of the release layer 103 protruding from the scratch layer 104, or the area of the scratch layer 104 is smaller than an area of a release layer 104 and the printing layer 105 is formed between the release layer 103 and the scratch layer 104 and on the portion of the release layer 103 protruding from the scratch layer 104, or a printing layer 501 made of temperature-indicating ink is formed on the scratch layer 104. As a result, when the scratch layer 104 is scratched off, the printing layers 105 and 501 are also partially broken, and the color of the printing layer 105 on the base material 10 becomes pale. For this reason, when a person who does a dishonest act tries to reproduce the scratch type printed material, not only the scratch layer 104 but also position, shape and color shade of the printing layers 105 and 501 should be reproduced, and thus the reproduction of the scratch type printed material becomes very difficult, thereby preventing dishonest acts.

### TECHNICAL FIELD

The present invention relates to a scratch type printed material.

### BACKGROUND ART

FIG. 1(a) is a plan view illustrating a conventional example of a scratch card as a scratch type printed material, and FIG. 1(b) is a sectional view taken along line VIb-VIb of FIG. 1(a). FIG. 1(c) is a plan view illustrating a state after a scratch layer of the scratch card shown in FIG. 1(a) is scratched off.

A scratch card 600 is a printed material which has a scratch layer 104 for being capable of masking secret information 102 covered with a release layer 103 printed on a card base material 101 as a printing base material and being scratched off.

Normally, a person who obtains the scratch card 600 scratches off the scratch layer 104 using, for example, an edge of a coin so as to obtain secret information (the drawing shows Roman number “II” (=2), but the information is not limited to this). Such kinds of scratch cards 600 are frequently used for lottery. Grades such as “1st grade” and “2nd grade”, numbers expressing points such as “1 point” and “2 points”, characters such as “jackpot” and “failure”, symbols such as “◯”, “Δ” and “×”, and character designs are printed as secret information.

The release layer 103 is a layer for preventing the secret information from being scratched off with the scratch layer 104, and normal varnish (not only varnish but also transparent resin) is used.

Some scratch cards 600 have a plurality of areas with the scratch layers 104 formed, and only a certain number of areas should be scratched off so that secret information such as “jackpot”, “failure” and “point” can be obtained (in many cases, if areas more than a specified number are scratched off, the scratch card becomes invalid).

Some people do dishonest acts on such scratch cards. For example, the entire scratch layers 104 are scratched off to acquire secret information, and scratched-off scratch layers 104 that had hidden unnecessary information are reproduced.

In order to cope with such dishonest acts, therefore, a technique that a non-masking layer portion is provided around a masking image portion of a scratch card is disclosed (for example, see Document 1).

Document 1: Japanese Patent Application Laid-Open No. 11-157265

### DISCLOSURE OF THE INVENTION

Problem to be Solved by the Invention

In the above conventional technique, small concavities and convexities, or a through hole is formed on a masking image portion. However, when distributors transport the scratch cards or purchasers carry the scratch cards, convex portions may be lost or concave portions are formed due to abrasion between the scratch cards.

The masking image portions having convexities and concavities, or through holes are possibly restructured with a silkscreen printing technique.

It is, therefore, an objective of the present invention is to provide a scratch type printed material that is hardly reproduced.

Means for Solving the Problem

In order to solve the above problem, the invention according to claim 1 is a scratch type printed material having a scratch layer that is formed on (“on” is used to include the ordinary meaning of “on” and “over” hereinafter) a release layer covering secret information on a base material, masks the secret information and is scratched off, wherein an area of the scratch layer is smaller than an area of the release layer, and a printing layer is formed on part of the release layer protruding from the scratch layer.

The invention according to claim 2 is the scratch type printed material according to claim 1, wherein a printing layer is formed on the scratch layer with the same ink as the printing layer.

The invention according to claim 3 is a scratch type printed material having a scratch layer that is formed on a release layer covering secret information on a base material, masks the secret information and is scratched off, wherein an area of the scratch layer is smaller than an area of the release layer, and a printing layer is formed between the release layer and the scratch layer and on part of the release layer protruding from the scratch layer.

The invention according to claim 4 is the scratch type printed material according to any one of claim 1 to 3, wherein the printing layer is formed across the release material and the base material.

In the invention according to claim 1, the area of the scratch layer is smaller than the area of the release layer, and the printing layer is formed on part of the release layer protruding from the scratch layer. As a result, when the scratch layer is scratched off, the printing layer on part of the release layer protruding from the scratch layer is also scratched off. It is very difficult to peel only the scratch layer avoiding the printing layer, and it is highly possible that the scratch layer remains around the printing layer. Therefore, when a person who does a dishonest act acquires the secret information and then tries to reproduce the scratch type printed material, it is difficult to guess a boundary between the scratch layer and the scratched-off printing layer. Even if someone tries to scratch off only the scratch layer, the scratch layer remains around the printing layer. For this reason, even if the secret information is masked by scratch ink improperly, since the scratch ink put on the residual scratch layer is in a so-called double-coated state, this portion becomes clearly unnatural and thus can be determined as the forged scratch type printed material. The present invention can produce the very high effect of the protection against forgery. The effect of protection against forgery may be heightened when the printing layer is formed using complicated patterns, colors and special materials.

In the invention according to claim 2, when the printing layer is formed on the scratch layer by using the same ink as the printing layer, the printing layer is formed not only on the portion of the release layer protruding from the scratch layer but also on the scratch layer, thereby further heightening the effect of protection against forgery. Since the printing layer on the portion of the release layer protruding from the scratch layer and the printing layer on the scratch layer are made of the same ink, they can be formed simultaneously. For this reason, the number of steps of manufacturing the scratch type printed material does not increase.

In the invention according to claim 3, the area of the scratch layer is smaller than the area of the release layer, and the printing layer is formed between the release layer and the scratch layer and on part of the release layer protruding from the scratch layer. As a result, when the scratch layer is scratched off, the printing layer between the release layer and the scratch layer, and the printing layer on the portion of the release layer protruding from the scratch layer are also scratched off. A person who does a dishonest act must reproduce the printing layer on the portion of the release layer protruding from the scratch layer and also the printing layer between the release layer and the scratch layer, and thus the forgery of the scratch type printed material is very difficult. Particularly the shape and color of the printing layer formed between the release layer and the scratch layer cannot be discriminated by visual inspection. Therefore, in order for the person who does a dishonest act to obtain the shape and color of the printing layer formed between the release layer and the scratch layer for forgery, only the scratch layer must be removed. However, when the scratch layer is scratched off, the printing layer formed between the release layer and the scratch layer is also scratched off, and thus the shape and the color of the printing layer formed between the release layer and the scratch layer cannot be acquired. The effect of protection against forgery can be heightened when the printing layer is formed using complicated patterns, colors and special materials.

In the invention according to claim 4, when the printing layer is formed across the release layer and the base material, the printing layer on the release layer is scratched off, and a deformation such as the fading of color of the printing layer on the base material due to rubbing can be seen. When a person who does a dishonest act acquires the secret information and then tries to reproduce the scratch type printed material, even if the scratch layer can be reproduced, it is difficult to restore a boundary between the scratch layer and the printing layer, and the color shade of the printing layer on the base material. For this reason, the effect of protection against forgery can be produced.

### EFFECTS OF THE INVENTION

According to the present invention, the area of the scratch layer is smaller than the area of the release layer and the printing layer is formed on part of the release layer protruding from the scratch layer, or the area of the scratch layer is smaller than the area of the release layer and the printing layer is formed between the release layer and the scratch layer and on the portion of the release layer protruding from the scratch layer. As a result, when the scratch layer is scratched off, the printing layer is also partially broken, and the printing layer on the base material is rubbed so that the color becomes pale. For this reason, when the person who does a dishonest act tries to reproduce the scratch type printed material, not only the scratch layer but also the position, shape and color shade of the printing layer should be restored. As a result, the reproduction of the scratch type printed material becomes very difficult, and thus dishonest acts can be prevented.

### BEST MODE FOR CARRYING OUT THE INVENTION

According to one exemplary embodiment, a scratch type printed material is formed so that a scratch layer that masks secret information and is scratched off is formed on (“on” is used to include the ordinary meaning of “on” and “over” hereinafter) a release layer that covers the secret information on a base material. An area of the scratch layer is smaller than an area of the release layer, and a printing layer is formed on a portion of the release layer that protrudes from the scratch layer. The printing layer may be formed on the scratch layer by using the same ink as that of the printing layer. Further, the printing layer may be formed across the release layer and the base material.

According to another exemplary embodiment, the scratch type printed material is formed where the scratch layer that masks secret information and is scratched off is formed on the release layer that covers the secret information on the base material. The area of the scratch layer is smaller than the area of the release layer, and the printing layer is formed between the release layer and the scratch layer and on the portion of the release layer that protrudes from the scratch layer. The printing layer may be formed across the release layer and the base material.

According to another exemplary embodiment, the scratch type printed material is constituted so that secret information is masked and scratched off on the release layer that covers the secret information on the base material. The printing layer made of heat-sensitive ink is formed on the scratch layer.

The printing layer may be formed in complicated patterns such as ground tint, fine figured pattern, characters, symbols and numbers, colors, and made of special materials.

As the printing layer, normal ink may be used, or a mixed product obtained by mixing a special material such as colored pearl pigment with ink may be used. Example of colored pearl pigment is infinite color, GG-02-L1 (made by Shiseido Co., Ltd.), rainbow color pearl pigment (product name: Iriodin 235 rutile platinum green made by Merck Ltd., Japan).

### First Embodiment

FIG. 2(a) is a plan view illustrating a scratch type printed material according to a first embodiment, and FIG. 2(b) is a sectional view taken along line Ib-Ib of FIG. 2(a). FIG. 2(c) is a plan view illustrating a state after the scratch layer of the scratch type printed material shown in FIG. 2(a) is scratched off, and FIG. 2(d) is a sectional view taken along line Id-Id of FIG. 2(c).

A scratch card is used to explain the following embodiments. Thickness of the respective layers on a printing base material is exaggerated for convenience of explanation. The same members as those in the conventional example shown in FIG. 1 are designated by the common numerals.

A scratch card 100 shown in FIGS. 2(a) and 2(b) is formed by a card base material (for example, paper) 101 as a printing base material, a scratch layer 104 that masks secret information 102 (in the drawings, Roman number “II”, but the secret information is not limited to this example) covered with a release layer 103 printed on the card base material 101 and can be scratched off, and a printing layer 105 that is formed so as to surround the perimeter of the scratch layer 104 together with the release layer 103. That is, the scratch card 100 has features: an area of the scratch layer is smaller than an area of the release layer 103; the printing layer 105 is formed on part of the release layer 103 that protrudes from the scratch layer 104.

The scratch card 100 can be obtained in the following manner. “II” as the secret information 102 is printed on the card base material 101 by using normal ink or an ink jet printer, and varnish is applied (printed) so as to cover “II” and is dried. After the release layer (in the drawing, circular shape, but the shape of the release layer is not limited to this example) 103 is formed, the scratch layer 104 (in the drawing, the scratch layer is a circular shape, but the shape of the scratch layer is not limited to a circle) is printed so as to mask “II”, and the printing layer 105 is printed so as to surround the perimeter of the scratch layer 104.

When the scratch layer 104 of the scratch card 100 is scratched off, the secret information 102 appears as shown in FIG. 2(c) because the release layer 103 is transparent. When a person who does a dishonest act acquires secret information tries to reproduce the scratch card 100, the scratch layer 104 may be reproduced with ink applied, but since the printing layer 105 is formed on the perimeter of the scratch layer 104 so as to surround the scratch layer 104, when the scratch layer 104 is scratched off, the printing layer 105 is also scratched off (at this time, although the printing layer 105 on the release layer 103 can be completely scratched off, the printing layer 105 on the card base material 101 cannot be scratched off and only the color becomes pale due to rubbing).

For this reason, even if the person who does a dishonest act tries to reproduce the scratch card 100, the scratch layer 104 may be reproduced but it is hardly possible to reproduce a position, a shape and a color shade of the scratched-off printing layer 105. As a result, the reproduction of the scratch card 100 becomes difficult, thereby preventing forgery.

It goes without saying that the effect of protection against forgery can be further heightened by using complicated patterns, colors and special materials for the printing layer.

### Second Embodiment

FIG. 3(a) is a plan view illustrating the scratch type printed material according to a second embodiment, and FIG. 3(b) is a sectional view taken along line IIb-IIb of FIG. 3(a). FIG. 3(c) is a plan view illustrating a state after the scratch layer of the scratch type printed material shown in FIG. 3(a) is scratched off, and FIG. 3(d) is a sectional view taken along line IId-IId of FIG. 3(c).

A different point between the first and second embodiments is that the printing layers 105 and 201 are formed not only on the perimeter of the scratch layer 104 but also on the scratch layer 104.

That is, this scratch card 200 is formed by the card base material 101, “II” as the secret information 102 printed on the card base material 101, the scratch layer 104 that masks the secret information 102 and can be scratched off, and the printing layers 105 and 201 that cover the release layer 103 and also part of the scratch layer 104. That is, as to the scratch card 200, the printing layer 501 is formed on the scratch layer 104 with the same ink as the printing layer 105.

The scratch card 200 can be obtained in the following manner. “II” is printed on the card base material 101, and varnish is applied (printed) so as to cover “II” and is dried. After the release layer 103 is formed, the scratch layer 104 is printed so as to mask “II”, and the printing layer 105 is printed so as to surround the perimeter of the scratch layer 104 and simultaneously the printing layer 201 is printed on the scratch layer 104.

In order to obtain the secret information 102, the printing layer 201 on the scratch layer 104 must be scratched off at the same time. At this time, even if the printing layer 105 on the release layer 103 can be entirely scratched off, the printing layer 105 on the card base material 101 is not completely scratched off and the color of the printing layer 105 simply becomes pale. For this reason, when a person who does a dishonest act acquires the secret information 102 and tries to reproduce the scratch layer 104, not only the printing layer 105 on the perimeter but also the printing layer 201 on the scratch layer 104 and the printing layer 105 on the card base material 101 should be reproduced. As a result, the reproduction of the scratch card 200 becomes extremely difficult, thereby further heightening the effect of protection against forgery.

When the printing layers are formed on the scratch layer with the same ink, the printing layers are formed not only on part of the release layer that protrudes from the scratch layer but also on the scratch layer. For this reason, the effect of the protection against forgery is further heightened. Since the same ink is used for the portion of the printing layer on the release layer protruding from the scratch layer and the printing layer on the scratch layer, these layers can be formed simultaneously. For this reason, the number of steps of manufacturing of the scratch type printed material does not increase.

### Third Embodiment

FIG. 4(a) is a plan view illustrating the scratch type printed material according to a third embodiment, and FIG. 4(b) is a sectional view taken along line IIIb-IIIb of FIG. 4(a). FIG. 4(c) is a plan view illustrating a state after the scratch layer of the scratch type printed material shown in FIG. 4(a) is scratched off, and FIG. 4(d) is a sectional view taken along line IIId-IIId of FIG. 4(c).

A different point between the third and first embodiments is that the printing layer covers the release layer and the scratch layer is formed on the printing layer.

That is, a scratch card 300 is formed by the card base material 101, the release layer 103 that covers “II” (the secret information 102 printed on the card base material 101), a printing layer 301 that covers the secret information including the release layer 103, and the scratch layer 104 that is formed on the printing layer 301 and can be scratched off. That is, in the scratch card 300, the area of the scratch layer 104 is smaller than that of the release layer 103, and the printing layer 301 is formed between the release layer 103 and the scratch layer 104 and part of the release layer 103 protruding from the scratch layer 104.

The scratch card 300 can be obtained in the following manner. “II” is printed on the card base material 101, and varnish is applied (printed) so as to cover “II” and is dried. After the release layer 103 is formed, the printing layer 301 is printed so as to cover the release layer 103, and the scratch layer 104 is printed on the printing layer 103 so as to cover “II”. Another printing layer may be formed on the scratch layer 104 (the number of steps increases due to the step of forming another printing layer in comparison with second embodiment).

As to the scratch card 300, when the scratch layer 104 is scratched off, the printing layer 103 between the release layer 103 and the scratch layer 104, and the printing layer 301 on part of the release layer 103 protruding from the scratch layer 104 are also scratched off. Therefore, a person who does a dishonest act should reproduce the printing layer 301 on part the release layer 103 protruding from the scratch layer 104 and should further reproduce the printing layer 301 between the release layer 103 and the scratch layer 104. As a result, forgery of the scratch type printed materials is very difficult. Particularly the shape and the color of the printing layer 301 formed between the release layer 103 and the scratch layer 104 cannot be discriminated by visual inspection. Therefore, in order that the person who does a dishonest act acquires the shape and color of the printing layer 301 formed between the release layer 103 and the scratch layer 104 for forgery, only the scratch layer 104 should be removed. However, when the scratch layer 104 is scratched off, the printing layer 301 formed between the release layer 103 and the scratch layer 104 is also scratched off. For this reason, practically, the shape and color of the printing layer 301 formed between the release layer 103 and the scratch layer 104 cannot be acquired. It goes without saying that when the printing layer 301 is formed by using complicated patterns, colors and special materials, the effect of protection against forgery can be heightened.

### Fourth Embodiment

FIG. 5(a) is a plan view illustrating the scratch type printed material according to a fourth embodiment, and FIG. 5(b) is a sectional view taken along line IVb-IVb of FIG. 5(a). FIG. 5(c) is a plan view illustrating a state after the scratch layer of the scratch type printed material shown in FIG. 5(a) is scratched off.

A different point between the fourth and first embodiments is that the printing layer is formed so as to surround the perimeter of the scratch layer including the release layer and extend inward from the perimeter between the scratch layer and the release layer.

A scratch card 400 can be obtained in the following manner. “II” is printed on the card base material 101, and varnish is applied (printed) so as to cover “II” and is dried. After the release layer 103 is formed, a printing layers 105-3 is formed so as to surround the release layer 103 and partially protrude inward from the perimeter onto the release layer 103. A scratch layer 104-3 is formed on the release layer 103 so as to cover the protruded portion of the printing layer 105-3. Further, as to the scratch card 400, before the scratch layer 104-3 is scratched off, only the region of the scratch layer 104-3 formed on the portion of the release layer 103 on the printing layer 105-3 rises up with respect to the other region of the scratch layer 104-3 so as to be visually checked. The raised region of the scratch layer 104-3 is formed in such a manner that when scratch ink is printed on the release layer 103, the scratch layer 104-3 rises due to uniform thickness of the scratch ink, the raised thickness being equal to the thickness of the printing layer 105-3 extending onto the release layer 103.

As to the scratch card 400, the printing layer is formed so as to surround the perimeter of the scratch layer including the release layer and be partially provided inwards from the perimeter between the scratch layer and the release layer, so that the partial rise on the peripheral portion of the scratch layer can be visually inspected after the scratch layer is printed. Once the scratch layer is scratched off and secret information is acquired, even if a person who does a dishonest act tries to form the scratch layer, the scratch layer becomes flat, and it is difficult to reproduce the raised portion of the scratch layer on the printing layer, thereby improving the effect of protection against forgery.

That is, the person who does a dishonest act should reproduce the printing layer on the portion of the release layer protruding from the scratch layer and should reproduce also the printing layer between the release layer and the scratch layer. As a result, the forgery of the scratch type printed materials becomes very difficult. Particularly the shape and the color of the printing layer formed between the release layer and the scratch layer cannot be detected by visual inspection. Therefore, in order that the person who does a dishonest act acquires the shape and color of the printing layer formed between the release layer and the scratch layer for forgery, only the scratch layer should be removed. However, when the scratch layer is scratched off, the printing layer formed between the release layer and the scratch layer is also scratched off, and thus practically the shape and color of the printing layer formed between the release layer and the scratch layer cannot be known. It goes without saying that when the printing layer is formed by complicated patterns, colors and special materials, the effect of protection against forgery can be heightened.

### Fifth Embodiment

FIG. 6(a) is a plan view illustrating the scratch type printed material according to a fifth embodiment, and FIG. 6(b) is a sectional view taken along line Vb-Vb of FIG. 6(a). FIG. 6(c) is a plan view illustrating a state after the scratch layer of the scratch type printed material shown in FIG. 6(a) is scratched off.

A different point between the fifth and first embodiments is that the printing layer that is made of heat-sensitive ink is formed on the scratch layer so as to partially cover the scratch layer.

That is, a scratch card 500 includes the card base material 101, the release layer 103 that covers “II” as secret information printed on the card base material 101, the scratch layer 104 that is formed on the release layer 103 and can be scratched off, and a printing layer 501 that is made of heat-sensitive ink is formed on the scratch layer 104 so as to partially cover the scratch layer 104.

The scratch card 500 is obtained in the following manner. “II” is printed on the card base material 101, and varnish is applied (printed) so as to cover “II” and is dried. After the release layer 103 is formed, the scratch layer 104 is printed so as to cover the release layer 103, and the printing layer 501 made of heat-sensitive ink is printed partially on the scratch layer 104.

When a person who does a dishonest act scratches off the scratch layer 104 to acquire the secret information 102 and tries to reproduce the scratch card 500, it is very difficult to reproduce the scratch layer 104 simultaneously with the scratched-off printing layer 501. Further, since it is hard to get the heat-sensitive ink, the reproduction of the scratch type printed material becomes difficult, thereby producing the effect of protection against forgery.

### INDUSTRIAL APPLICABILITY

The present invention can be applied to scratch cards, advertisement leaflets for promotion, brochures and the like.

### BRIEF DESCRIPTION OF THE DRAWINGS

FIG. 1(a) is a plan view illustrating a scratch card as a scratch type printed material according to a conventional example, FIG. 1(b) is a sectional view taken along line VIb-VIb of FIG. 1(a), and FIG. 1(c) is a plan view illustrating a state after a scratch layer of the scratch card shown in FIG. 1(a) is scratched off;

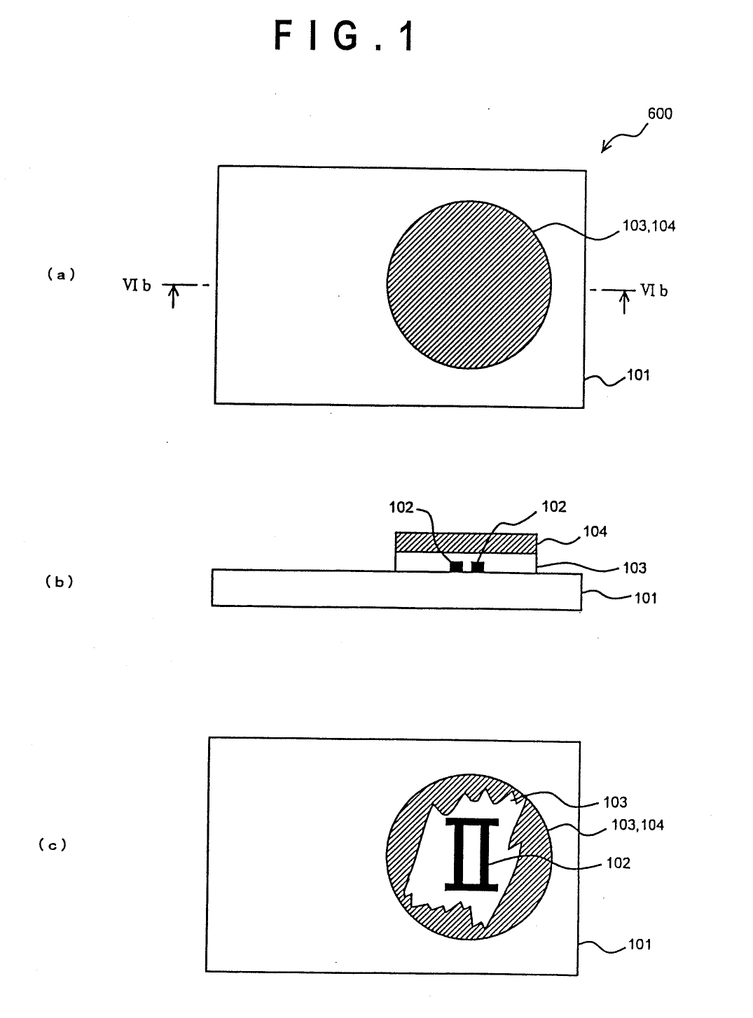

FIG. 2(a) is a plan view illustrating a scratch type printed material according to a first embodiment of the present invention, FIG. 2(b) is a sectional view taken along line Ib-Ib of FIG. 2(a), FIG. 2(c) is a plan view illustrating a state after the scratch layer of the scratch type printed material shown in FIG. 2(a) is scratched off, and FIG. 2(d) is a sectional view taken along line Id-Id of FIG. 2(c);

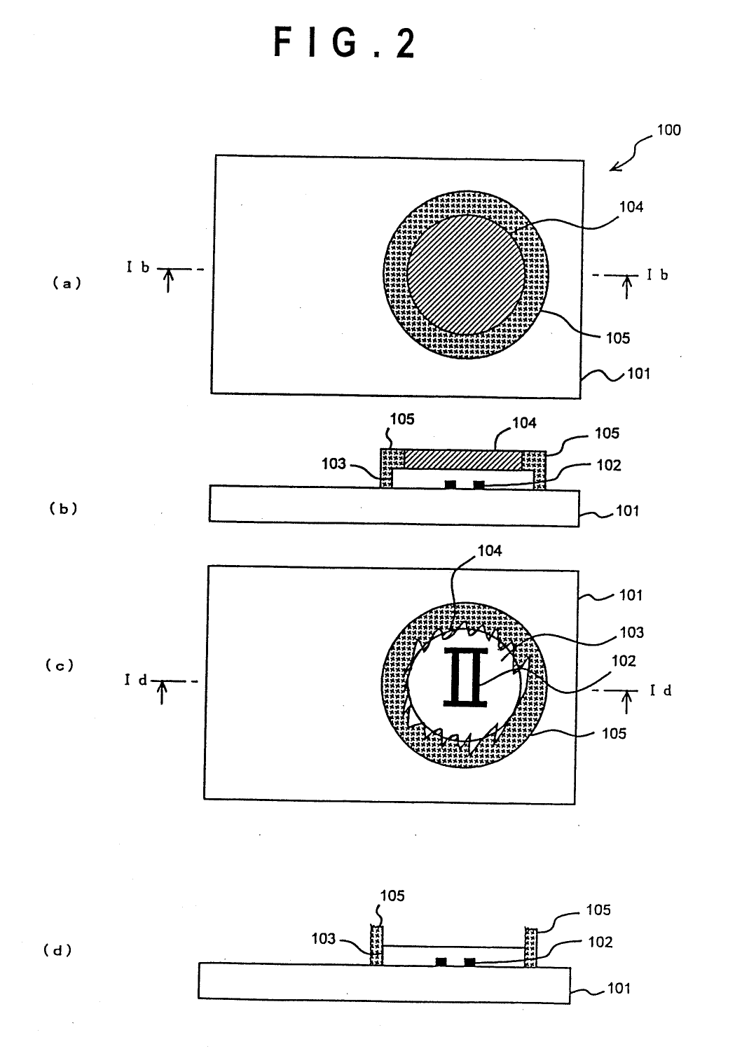

FIG. 3(a) is a plan view illustrating a scratch type printed material according to a second embodiment of the present invention, FIG. 2(b) is a sectional view taken along line Ib-Ib of FIG. 2(a), FIG. 2(c) is a plan view illustrating a state after the scratch layer of the scratch type printed material shown in FIG. 3(a) is scratched off, and FIG. 3(d) is a sectional view taken along line IId-IId of FIG. 3(c);

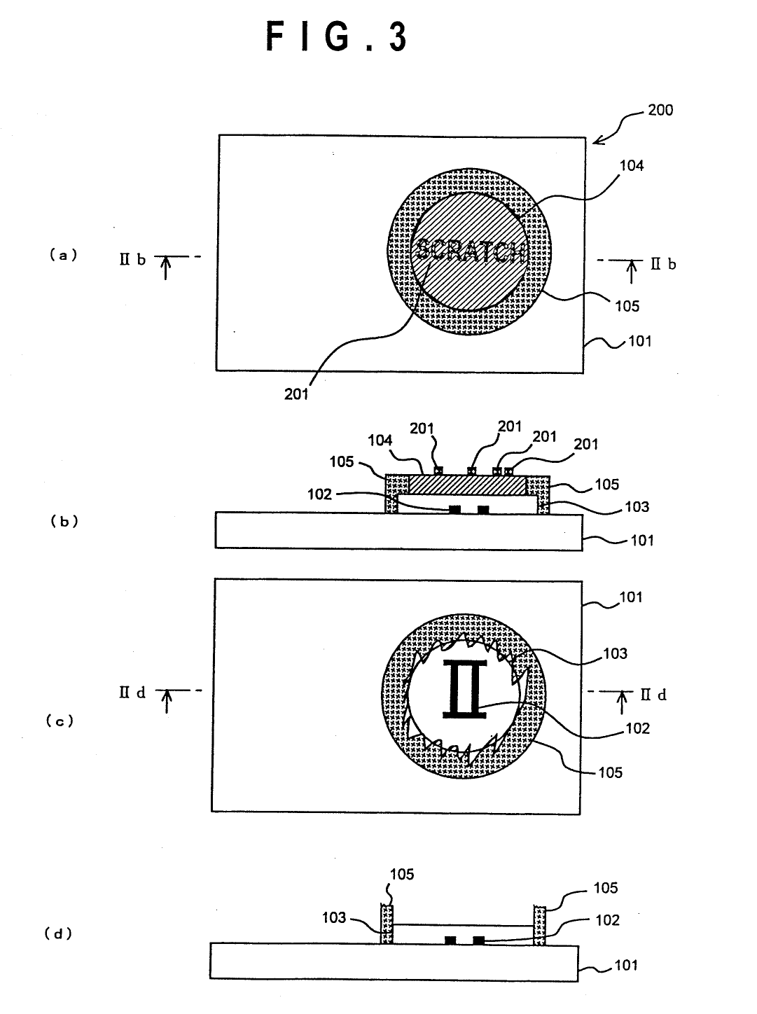

FIG. 4(a) is a plan view illustrating a scratch type printed material according to a third embodiment of the present invention, FIG. 4(b) is a sectional view taken along line IVb-IVb of FIG. 4(a), FIG. 4(c) is a plan view illustrating a state after the scratch layer of the scratch type printed material shown in FIG. 4(a) is scratched off, and FIG. 4(d) is a sectional view taken along line IIId-IIId of FIG. 3(c);

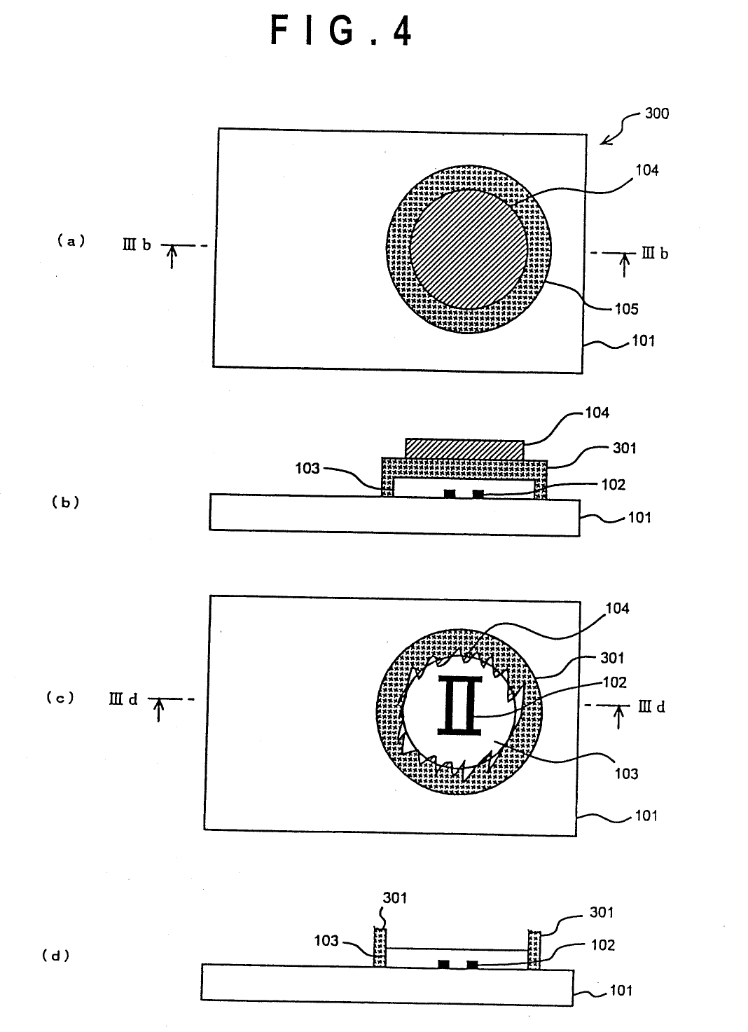

FIG. 5(a) is a plan view illustrating a scratch type printed material according to a fourth embodiment of the present invention, FIG. 5(b) is a sectional view taken along line IVb-IVb of FIG. 5(a), and FIG. 5(c) is a plan view illustrating a state after the scratch layer of the scratch type printed material shown in FIG. 5(a) is scratched off.

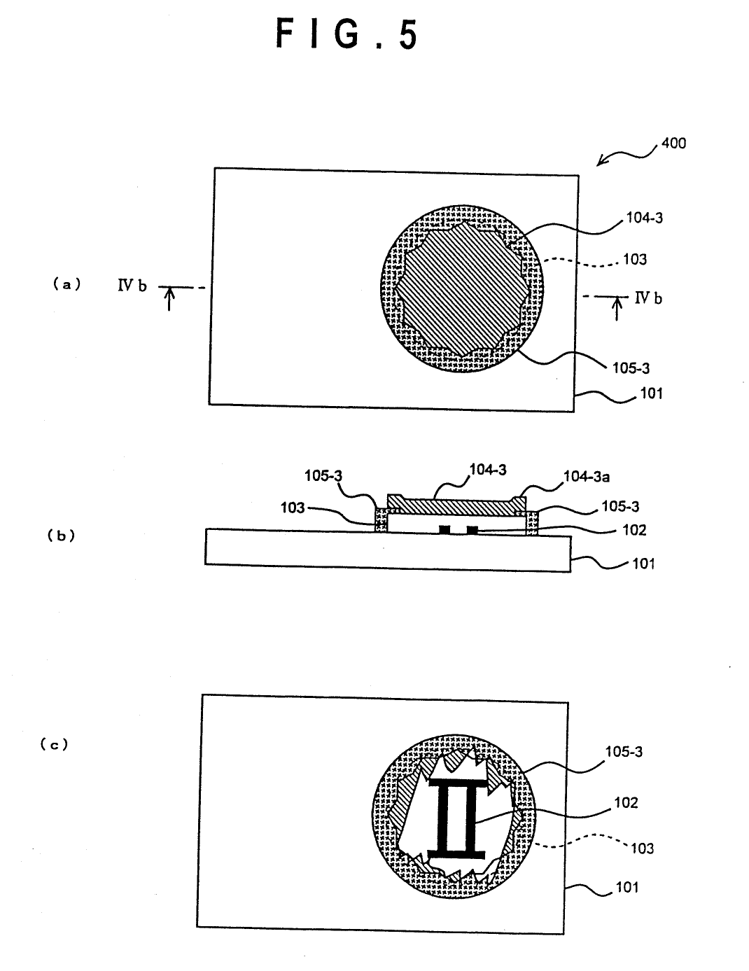

FIG. 6(a) is a plan view illustrating a scratch type printed material according to a fifth embodiment of the present invention, FIG. 6(b) is a sectional view taken along line Vb-Vb of FIG. 6(a), and FIG. 6(c) is a plan view illustrating a state after the scratch layer of the scratch type printed material shown in FIG. 6(a) is scratched off.

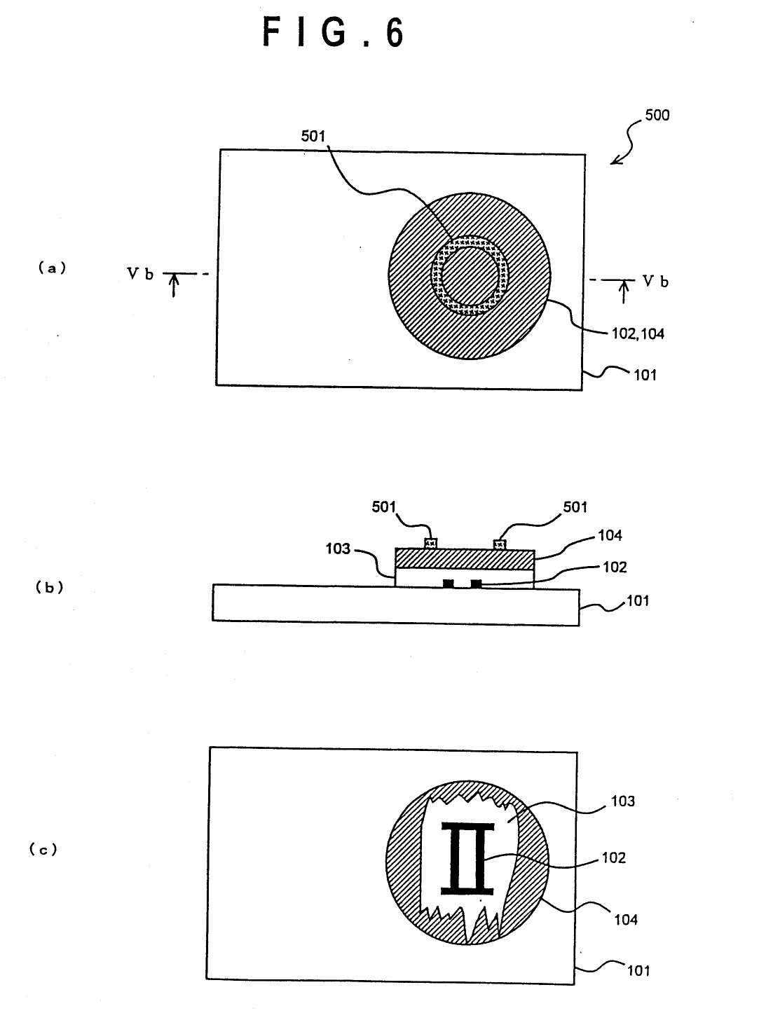

### EXPLANATIONS OF LETTERS OR NUMERALS

100: scratch card
101: card base material (printing base material)
102: secret information
103: release layer
104: scratch layer
105: printing layer

1. A scratch type printed material having a scratch layer that is formed on a release layer covering secret information on a base material, masks the secret information and is scratched off,
wherein an area of the scratch layer is smaller than an area of the release layer, and a printing layer is formed on part of the release layer protruding from the scratch layer.

2. The scratch type printed material according to claim 1, wherein a printing layer is formed on the scratch layer with the same ink as the printing layer.

3. A scratch type printed material having a scratch layer that is formed on a release layer covering secret information on a base material, masks the secret information and is scratched off,
wherein an area of the scratch layer is smaller than an area of the release layer, and a printing layer is formed between the release layer and the scratch layer and on part of the release layer protruding from the scratch layer.

4. The scratch type printed material according to claim 1, wherein the printing layer is formed across the release material and the base material.

5. The scratch type printed material according to claim 2, wherein the printing layer is formed across the release material and the base material.

6. The scratch type printed material according to claim 3, wherein the printing layer is formed across the release material and the base material.
